(19) United States
(12) Patent Application Publication
(10) Pub. No.: US 2016/0330996 A1
(43) Pub. Date: Nov. 17, 2016

(54) ICE CREAM BAR MAKER

(71) Applicant: DONG HWAN SUL, Hawaiian Gardens, CA (US)

(72) Inventor: DONG HWAN SUL, Hawaiian Gardens, CA (US)

(21) Appl. No.: 14/710,584

(22) Filed: May 12, 2015

(51) Int. Cl. A23G 9/28; A23G 9/22

(52) U.S. Cl. CPC A23G 9/286; A23G 9/224; A23G 9/222

(57) ABSTRACT

An ice cream bar maker comprises a plurality of ice cream bar molds, a canister that receives the ice cream bar molds, a freezing fluid medium filled in the canister, an agitating device that agitates the freezing fluid medium and a freezing device that removes heat from the canister. The freezing fluid medium contacts the ice cream bar molds whereby removing heat from the ice cream bar molds. The canister comprises a hollow main body with a top opening and a canister cover that covers the top opening. The canister cover comprises a plurality of holes into which the ice cream bar molds are inserted. The ice cream bar mold comprises an elongated cylindrical mold body and a plurality of heat transfer fins that is attached to the mold body.

### FIELD OF THE INVENTION

The present invention is related to an ice cream bar maker. More specifically, the present invention is related to an ice cream bar having multiple-serving capacity for commercial facilities.

### BACKGROUND OF THE INVENTION

Demands for on-site ice cream with natural ingredients are ever increasing. On-site preparation of ice cream must be done in a reasonably short time so that a customer would not be bored and would not lose interest in watching the ice cream preparation process starting from ingredient in front of the customer. An on-site ice cream maker also needs to minimize labor of a store clerk so that she would not be exhausted. Design of a commercial ice cream bar maker achieving fast preparation and minimizing human labor is a difficult task involving many complex factors.

None of the prior arts provide an labor-efficient and fast-preparing ice cream bar maker with compact and simple structure aesthetically appealing to customers in an ice cream shop setting.

### BRIEF SUMMARY OF THE INVENTION

An objective of the invention is to provide a multi-serving capacity ice cream bar maker that can make ice cream bars in considerably short time.

Another objective of the present invention is to provide a multi-serving capacity ice cream bar maker that can minimize manual labor of a store clerk who operates the ice cream bar maker.

In order to achieve the objectives, in an embodiment, the present invention provides an ice cream bar maker comprising a plurality of ice cream bar molds, a canister that receives the bar molds, a freezing fluid medium filled in the canister, an agitating device that agitates the freezing fluid medium and a freezing device that removes heat from the canister. The freezing fluid medium contacts the ice cream bar molds whereby removing heat from the ice cream bar molds.

The canister comprises a hollow main body with a top opening and a canister cover that covers the top opening. The canister cover comprises a plurality of holes into which the ice cream bar molds are inserted, and one or more handles attached on a periphery of the canister cover.

The ice cream bar mold comprises an elongated cylindrical mold body. The mold body comprises a top open end, a bottom closed end and an annular flange near the top open end. The annular flange abuts a top surface of the canister cover.

The agitating device comprises a cover rotating device that rotates the canister cover with respect to the main body, and a cover rotating device switch that stops the cover rotating device when the canister cover is lifted from the main body of the canister. The ice cream bar maker further comprises a case that houses the canister and the freezing device. The case comprises a top plate that comprises a canister receiving opening for inserting the canister into the case. The cover rotating device is installed on the top plate near the canister receiving opening. The canister cover comprises an annular rim. The cover rotating device comprises one or more rotating rollers that contact the annular rim.

The freezing device comprises an evaporator coil, an expansion valve, a condenser and a compressor. The evaporator coil is installed inside the canister and removes heat from the freezing fluid medium. The ice cream bar maker further comprises an insulating case that surrounds the main body of the canister. The main body of the canister comprises a drain hole.

Preferably, the ice cream bar mold has a diameter within a range from about 1.0 inch to about 1.2 inch. The ice cream bar mold may further comprise a plurality of heat transfer fins that is attached to the mold body.

The freezing medium may be air, or a liquid that has a freezing point lower than the freezing point of water.

In another embodiment, the agitating device comprises a blower that generates fluid flow inside the canister, and a blower switch that stops the blower when the canister cover is lifted from the main body of the canister.

The advantageous effects of the present invention are: (1) the ice cream bar maker can accommodated multiple orders due to multiple number of molds, (2) ingredients in the molds are frozen fast due to rapid heat transfer, (3) the ice cream bar maker is compact and easy to maintain because of its simple structure.

### BRIEF DESCRIPTION OF THE DRAWINGS

The invention will be more fully understood by reference to the detailed description in conjunction with the following figures, wherein:

FIG. 1 is a perspective view of an ice cream bar maker according to the present invention;

FIG. 2 is a cross-sectional view of a canister with ice cream bar molds inserted;

FIG. 3 is a cross-sectional view of an ice cream bar mold;

FIG. 4 is a cross-sectional view of the ice cream bar mold with heat transfer fins attached;

FIG. 5 is a cross-sectional view of the ice cream bar mold take along line V-V in FIG. 4;

FIG. 6 is an illustrative cross-sectional view of the inside of the ice cream bar maker;

FIG. 7 is a cross-sectional view of the canister with a canister cover rotating device as an agitation device; and

FIG. 8 is a cross-sectional view of the canister with a blower as an agitation device.

### DETAILED DESCRIPTION OF THE INVENTION

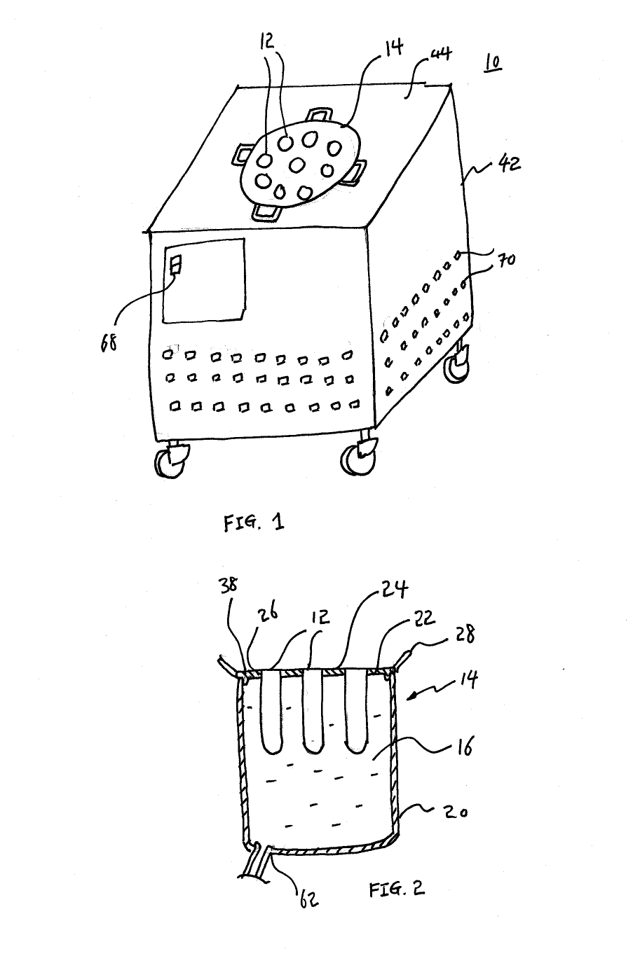

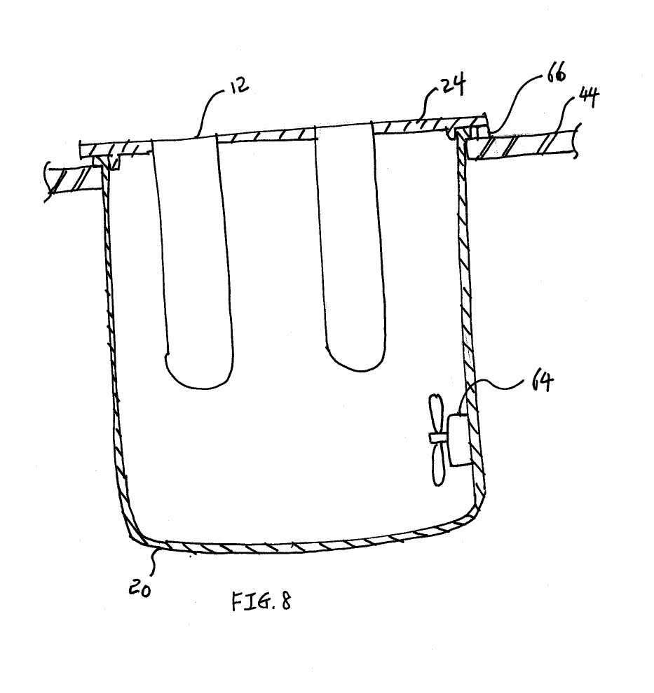

FIGS. 1 and 2 show an ice cream bar maker 10 comprising a plurality of ice cream bar molds 12; a canister 14 that receives the ice cream bar molds 12; a freezing medium 16 filled in the canister 14; an agitating device 17 (refer to FIGS. 7 and 8) that agitates the freezing fluid medium 16, and a freezing device 18 that removes heat from the canister 14 (refer to FIG. 6). The freezing fluid medium 16 contacts the ice cream bar molds 12 whereby removing heat from the ice cream bar molds 12.

Referring to FIG. 2, the canister 14 comprises a hollow main body 20 with a top opening 22 and a canister cover 24 that covers the top opening 22. The canister cover 24 comprises a plurality of holes 26 into which the ice cream bar molds 12 are inserted, and one or more handles 28 attached on a periphery of the canister cover 24.

Referring to FIG. 3, the ice cream bar mold 12 comprises an elongated cylindrical mold body 30. The mold body 30 comprises a top open end 32, a bottom closed end 34 and an annular flange 36 near the top open end 32. The annular flange 36 abuts a top surface 38 of the canister cover 24. The ice cream bar mold 12 is made of stainless steel, or any material having good heat conductivity.

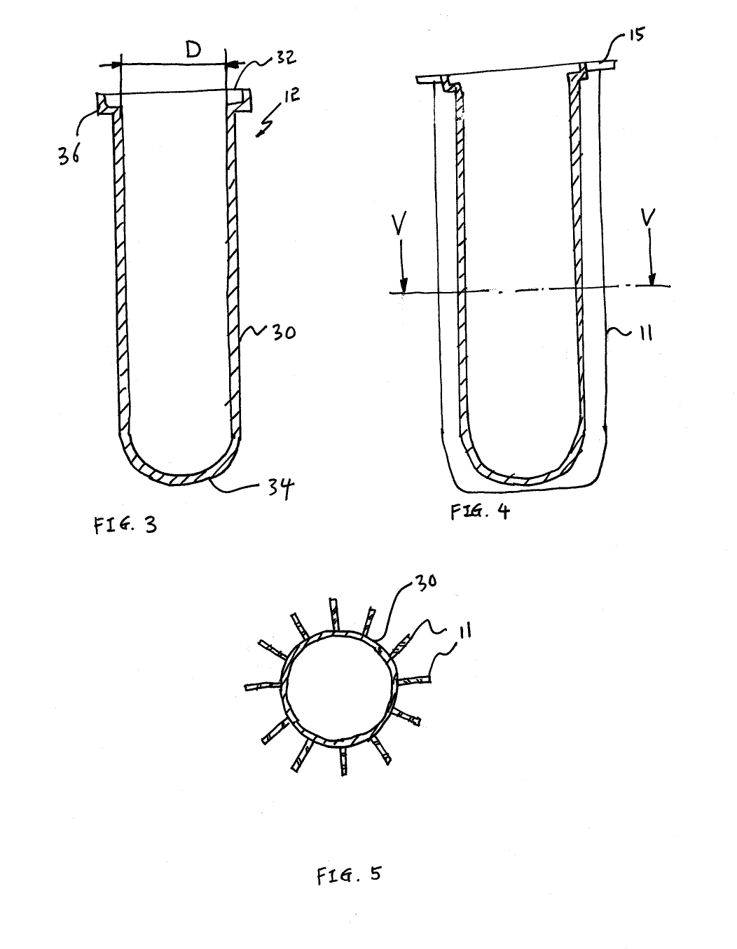

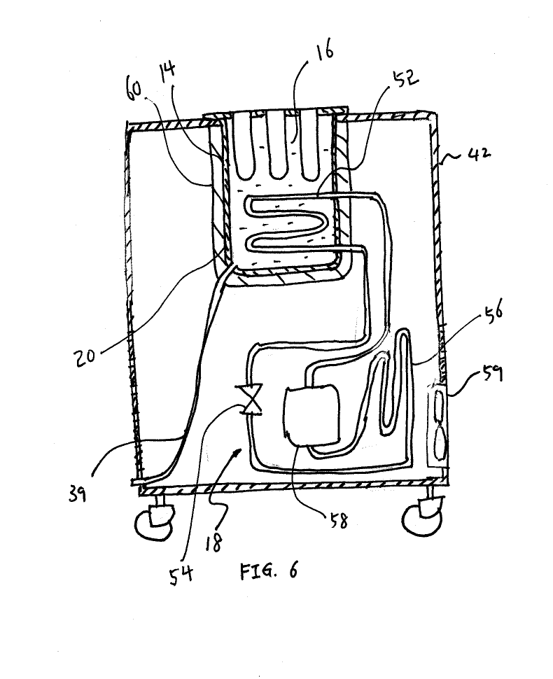

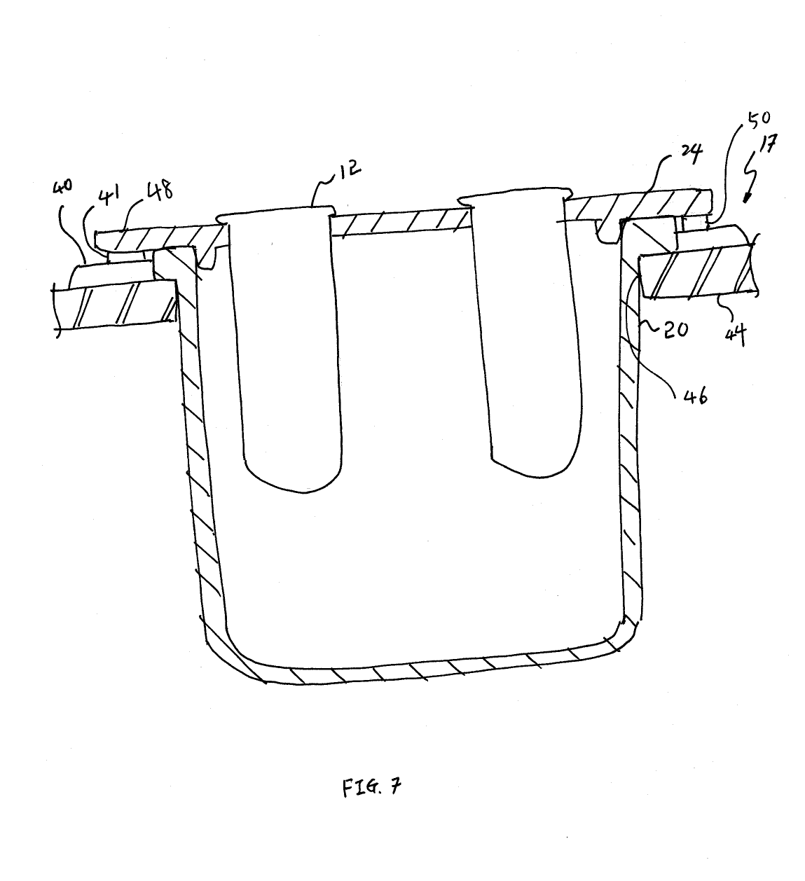

Referring to FIGS. 4 and 5, the ice cream bar mold 12 further comprises a plurality of heat transfer fins 11 that is attached to the mold body 30. A fin flange 15 is provided to be placed on the top surface of the canister cover 24. The fin 11 and the fin flange 15 may be integrally made with the mold body 30.

Referring to FIG. 7, the agitation device 17 comprises a cover rotating device 40 that rotates the canister cover 24 with respect to the main body 20, and a cover rotating device switch 41 that stops the cover rotating device 40 when the canister cover 24 is lifted from the main body 20 of the canister 14. The cover rotating device switch 41 starts the cover rotating device 40 when the canister cover 24 is placed back on the main body 20 of the canister 14. The cover rotating device switch 41 is provided as a button switch that is pushed by weight of the canister cover 24. The ice cream bar maker 10 further comprises a case 42 that houses the canister 14 and the freezing device 18. The case 42 comprises a top plate 44 that comprises a canister receiving opening 46 for inserting the canister 14 into the case 42. The cover rotating device 40 is installed on the top plate 44 near the canister receiving opening 46. The canister cover 24 comprises an annular rim 48. The cover rotating device 40 comprises one or more rotating rollers 50 that contact the annular rim 48.

Referring to FIG. 6, the freezing device 18 comprises an evaporator coil 52, an expansion valve 54, a condenser 56 and a compressor 58. The evaporator coil 52 is installed inside the canister 14 and removes heat from the freezing fluid medium 16. The ice cream bar maker 10 further comprises an insulating case 60 that surrounds the main body 20 of the canister 14. The main body 20 of the canister 14 comprises a drain hole 62. The size of the drain hole 62 is about 1 inch and a hose 39 is connected to the drain hole 62 to exhaust condensate water from the ice cream bar maker 10). A fan 59 moves air out of the case 42 to remove air heated by the condenser 56. Referring back to FIG. 1, the ice cream bar maker 10 further comprises a main switch that operates the freezing device 18, and vent holes 70 on the four side walls of the case 42.

Preferably, the ice cream bar mold 12 has a diameter D within a range from about 1.0 inch to about 1.2 inch.

The freezing fluid medium 16 may be air, or a liquid that has a freezing point lower than the freezing point of water.

Referring FIG. 8, the agitating device 17 comprises a blower 64 that generates fluid flow inside the canister 14, and a blower switch 66 that stops the blower 64 when the canister cover 24 is lifted from the main body 20 of the canister 14.

The invention covers any structure that can simultaneously remove heat from multiple number of ice cream molds. The freezing device may comprise evaporator coils directly attached to the canister cover, and ingredients in the ice cream molds can be frozen by heat transfer through conduction and/or convection.

The above description is illustrative and is not restrictive, and, as it will become apparent to those skilled in the art upon review of the disclosure, the present invention may be embodied in other specific forms without departing from the essential characteristics thereof. The scope of the invention should, therefore, be determined not with reference to the above description, but instead should be determined with reference to the following and pending claims along with their full scope of equivalents.

1. An ice cream bar maker comprising:
a) a plurality of ice cream bar molds;
b) a canister that receives the ice cream bar molds;
c) a freezing fluid medium filled in the canister;
d) an agitating device that agitates the freezing fluid medium; and
d) a freezing device that removes heat from the canister;
wherein the freezing fluid medium contacts the ice cream bar molds whereby removing heat from the ice cream bar molds;
wherein the canister comprises a hollow main body with a top opening and a canister cover that covers the top opening, wherein the canister cover comprises a plurality of holes into which the ice cream bar molds are inserted.

2. The ice cream bar maker of claim 1, wherein the ice cream bar mold comprises an elongated cylindrical mold body, wherein the mold body comprises a top open end, a bottom closed end and an annular flange near the top open end, wherein the annular flange abuts a top surface of the canister cover.

3. The ice cream bar maker of claim 2, wherein the freezing device comprises an evaporator coil, an expansion valve, a condenser and a compressor, wherein the evaporator coil is installed inside the canister and removes heat from the freezing fluid medium.

4. The ice cream bar maker of claim 3, further comprising an insulating case that surrounds the main body of the canister.

5. The ice cream bar maker of claim 4, wherein the ice cream bar mold has a diameter within a range from about 1.0 inch to about 1.2 inch.

6. The ice cream bar maker of claim 4, wherein the main body of the canister comprises a drain hole.

7. The ice cream bar maker of claim 4, wherein the freezing fluid medium is air.

8. The ice cream bar maker of claim 4, wherein the freezing fluid medium is a liquid that has a freezing point lower than the freezing point of water.

9. The ice cream bar maker of claim 4, further comprising a case that houses the canister and the freezing device, wherein the case comprises a top plate that comprises a canister receiving opening for inserting the canister into the case.

10. The ice cream bar maker of claim 4, wherein the agitating device comprises a cover rotating device that rotates the canister cover with respect to the main body.

11. The ice cream bar maker of claim 10, wherein the agitating device further comprises a cover rotating device switch that stops the cover rotating device when the canister cover is lifted from the main body of the canister.

12. The ice cream bar maker of claim 4, wherein the agitating device comprises a blower that generates fluid flow inside the canister.

13. The ice cream bar maker of claim 12, wherein the agitating device further comprises a blower switch that stops the blower when the canister cover is lifted from the main body of the canister.

14. The ice cream bar maker of claim 4, wherein the ice cream bar mold further comprises a plurality of heat transfer fins that is attached to the mold body.
